(19) United States
(12) Patent Application Publication
(10) Pub. No.: US 2024/0178649 A1
(43) Pub. Date: May 30, 2024

(54) CUSTOMIZABLE OVERCURRENT PROTECTION ASSISTANT

(71) Applicant: Joseph M. DeLapa, II, Proctorville, OH (US)

(72) Inventor: Joseph M. DeLapa, II, Proctorville, OH (US)

(21) Appl. No.: 18/432,011

(22) Filed: Feb. 4, 2024

Related U.S. Application Data
(63) Continuation-in-part of application No. 17/148,763, filed on Jan. 14, 2021, now Pat. No. 11,923,677.

(51) Int. Cl. H02H 3/08; H02H 1/00

(52) U.S. Cl. CPC H02H 3/08; H02H 1/0092

(57) ABSTRACT

The present invention pertains to a method and apparatus, disclosed for assisting a user with configuring an integrated circuit devised to facilitate the generation of customizable solar energy generation systems. Responsive to the user utilizing a user interface (UI) by specifying inputs, the UI identifies requirements for load requirements and offer customizable module recommendations. The UI incorporates graphical representations, interactive elements, tooltips, hyperlinked terms, language localization, and augmented reality/virtual reality features, aimed at elucidating intricate solar energy system-related concepts.

If an Application Data Sheet (ADS) has been filed for this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a utility application related to and claims the benefit of priority as a continuation-in-part of U.S. patent application Ser. No. 17/148,763, filed on Jan. 14, 2021.

### BACKGROUND

The present invention relates to a computing environment, and more particularly to a system supporting tailoring overcurrent protections based on user requirements.

### SUMMARY

According to one embodiment of the invention, there is a method for assisting a user with configuring an integrated circuit with customizable overcurrent protection. A user interface (UI) is provided that allows a user to specify inputs to an apparatus. The apparatus supports connecting user customizable plug and play components to the integrated circuit. Responsive to the user utilizing the UI by specifying inputs, the UI identifies requirements for overcurrent protection elements in the apparatus.

According to one embodiment of the invention, there is provided an information handling system including at least one processor executing instructions implementing steps of the method that assists the user with configuring an integrated circuit with customizable overcurrent protection.

According to one embodiment of the invention, there is provided a computing program product executing instructions having the steps of the method that assists the user with configuring an integrated circuit with customizable overcurrent protection.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 shows a modular wiring diagram of a modular overcurrent protection apparatus;

FIG. 2 shows a schematic view of embodiment 1 of a modular overcurrent protection apparatus;

FIG. 3 shows a schematic view of embodiment 2 of a modular overcurrent protection apparatus;

FIG. 4 shows an interior view of the embodiment 2 of a modular overcurrent protection apparatus;

FIG. 5 shows a visual representation of example customizable components that may be applied to a modular overcurrent protection apparatus;

FIG. 6 shows a schematic view a user interface tailored to a modular overcurrent protection apparatus;

FIG. 7 shows a schematic view of user input options;

FIG. 8 shows a schematic view of output suggestions from the software;

FIG. 9 shows a schematic view of output suggestions in graphical way;

FIG. 10 shows a schematic view of a computing system; and

FIG. 11 shows a schematic view of the computing system with multiple devices.

### DETAILED DESCRIPTION

Solar, wind, and other forms of renewable energy are becoming more popular worldwide as an alternative energy source for a number of reasons including lower cost for production, increasing pollution from fossil fuels, and lack of other viable energy resources.

Currently, a user may purchase a product tailored to meet specific requirements, the user may specify the specific parts and buy a module tailored for the specified purpose. For example, there are several solar energy systems that may be purchased, but they include non-customizable circuitry and/or components.

In order to overcome the deficiencies of the prior art, a modular generic apparatus is disclosed herein that may be used to create a simple, safe, and user-friendly energy generation and storage system. The disclosed system supports receiving customizable power input and power output for energy generating systems and energy storage. Example embodiments may include essential elements of a customizable protective circuitry supporting modular integration of components in a “plug-and-play” fashion. By way of example, without any limitation implied, applications of the embodiments could include off-grid scenarios, on-grid scenarios, recreational vehicles, educational applications, and the like.

Embodiments of the apparatus may include a common modular circuit for integration of multiple components including (but not limited to) a direct current (DC) source (e.g. photovoltaic array) of varying voltage, a charge controller, a DC energy storage (e.g. battery bank), an alternating current (AC) inverter, a DC fuse block, a circuit disconnect, and a multimeter. The apparatus may also support user-friendly selection of components, assisted installation, and customization of circuitry, such as and fuses/breakers with varying amperage.

An overcurrent is a condition which exists in an electrical circuit when the normal load current is exceeded. The two basic forms of an overcurrent are overloads and short circuits. Fuses and circuits breakers primary role in a circuit is to protect personnel and equipment when dangerous overcurrent's do happen. A short-circuit is an overcurrent condition where an abnormal, low-resistance, circuit path is introduced into the circuit. This low-resistance path bypasses the normal load and can create extremely high currents (up to 1000× the normal current under some conditions). An overload is an overcurrent condition where the current exceeds the normal full load-capacity of the circuit but where no fault condition (short-circuit) is present. A momentary overload condition (also known as “in-rush” currents) may also occur when a circuit is first initialized due to capacitor charging and/or motor-startup.

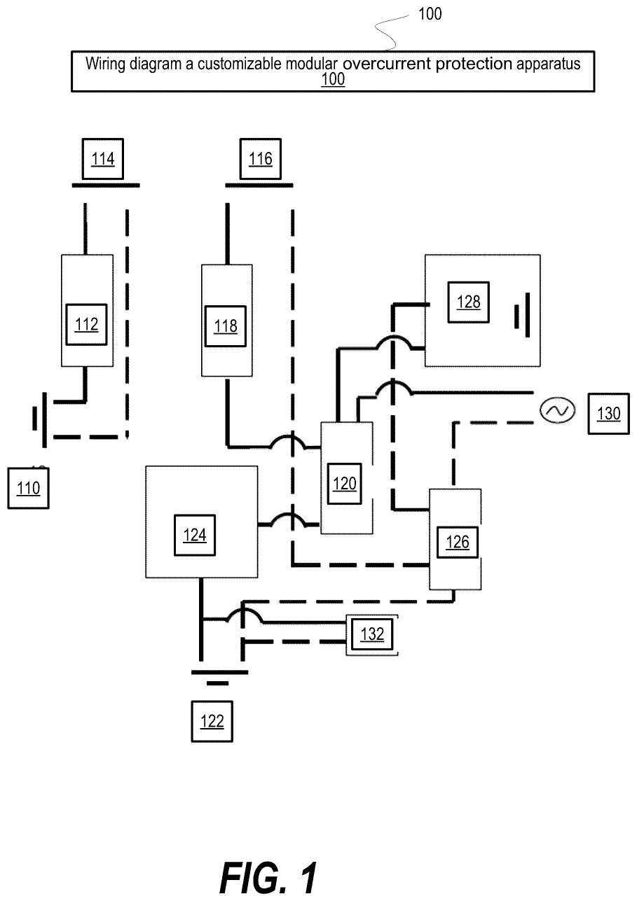

FIG. 1 depicts an embodiment of a wiring diagram 100 of a customizable circuit. The apparatus includes an input 110 for DC current [for example, solar], thereafter current passes through an adaptable fuse/breaker 112 to a common DC output 114 and to a charge controller 116 of choice which may be defined by the user. The apparatus may also offer an input for DC current into the circuit from the charge controller 116 thereafter current flows through an adaptive fuse/breaker 118 onward to the main fuse/breaker 120 which is customizable based upon component amperage. In addition, the device may provide an output 122 for DC current storage and utilization (eg. battery bank) that is user defined based upon user selection and passes through a circuit disconnect 124, thereafter current passes to the adaptive main fuse 120. From the main fuse 120, the DC current passes to an integrated DC fuse block 128 and also a DC output for attachment of an AC inverter 130 per the user preference. In addition, a multimeter (volt, amp, watt) 132 may be available. All the negative terminals may be attached to the negative busbar 126. However, if the solar array DC output is already fused, then the corresponding segment may be bypassed. In addition, an embodiment of the device may incorporate electrical conduit allowing for varying amperage based upon user defined needs. In addition, the fuse/breaker components may be customizable in a “Plug and Play” fashion.

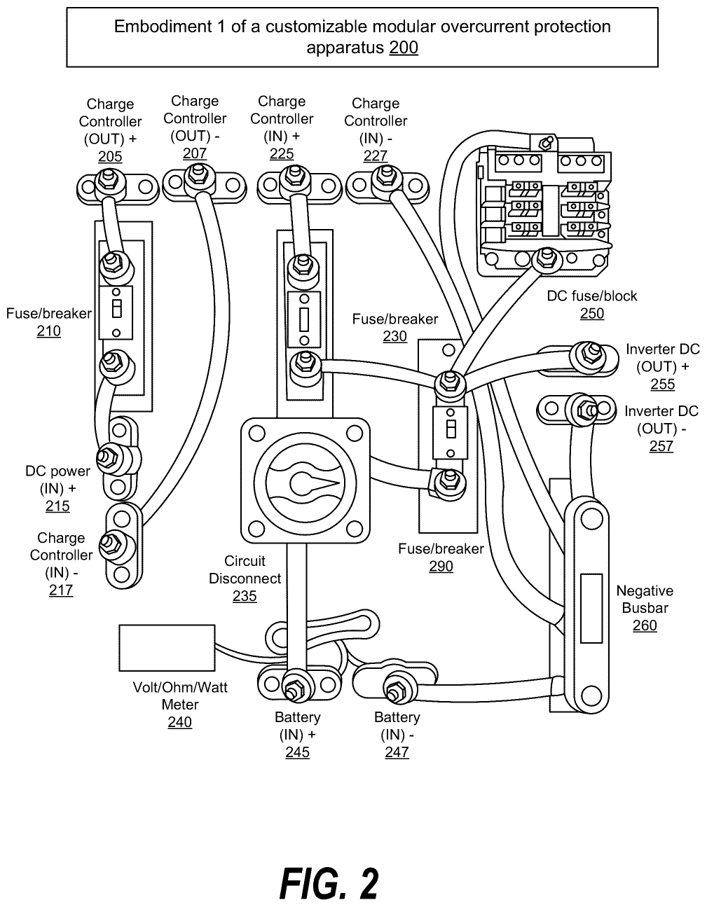

FIG. 2 depicts embodiment 1 of a customizable modular overcurrent protection apparatus 200. The customizable overcurrent protection apparatus 200 includes various connection ports, such as, DC power (IN) − 217 operatively connected to charge controller (OUT) − 207. DC power (IN) + 215 connected to fuse/breaker 210 connected to charge controller (OUT) + 205. Charge controller (IN) + 225 connected to fuse/breaker 230 operatively coupled to DC fuse/block 250, inverter DC out + 255, fuse/breaker 290, circuit disconnect 235, and battery (IN) + 245 which is connected to volt/ohm/watt meter 240. Charge controller (IN) − 227 connected to negative busbar 260 which is connected to battery (IN) − 247 and inverter DC out − 257.

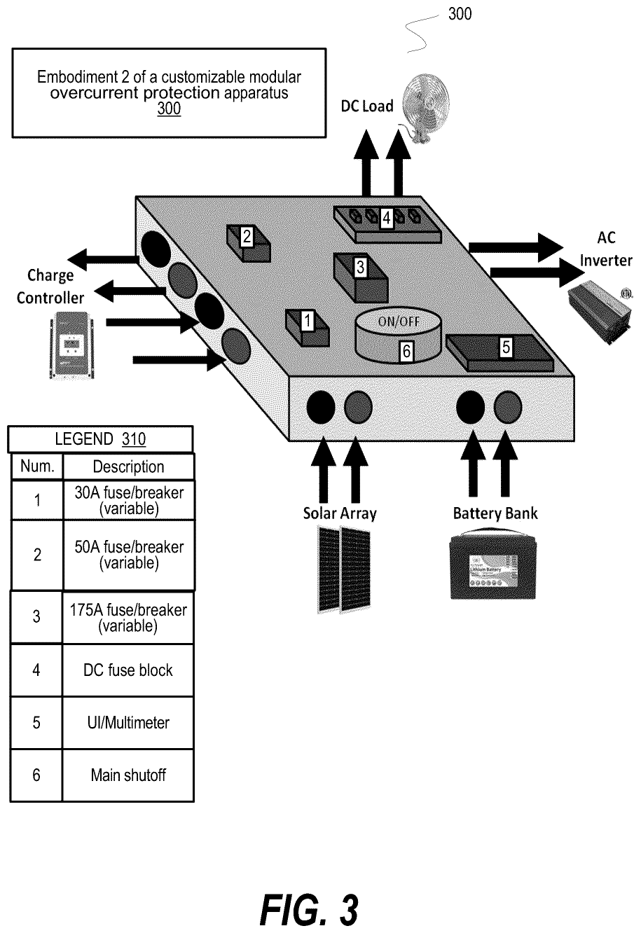

FIG. 3 depicts a schematic view of embodiment 2 of a customizable modular overcurrent protection apparatus 300. The view depicts ports for the charge controller, solar array, battery bank, AC inverter and DC load. The numbered entries are documented in legend 310, where 1 is 30 A fuse/breaker variable, 2 is 50 A fuse/breaker variable, 3 is 175 fuse/breaker (variable), 4 is DC fuse block, 5 is Lil/multimeter, and 6 is main shutoff.

For example, if a user desires a 3600 Watt 12 Volt solar generation system, the user may be planning to use a 400 watt solar panel array, a 40 A charge controller, a 3600 Watt battery bank and 1500 Watt AC inverter. Based upon these inputs by the user, the UI would calculate a 30 A fuse for fuse point #1 to allow proper over current protection of the solar array (note, this fuse point is optional if the solar array uses a fused combiner box, or in-line fuse), a 50 Amp fuse for fuse point #2 of charge controller, and a 175 Amp fuse for main fuse (fuse point #3) connecting battery bank to AC inverter and DC load in order to provide adequate over current protection. Of note, the UI calculations can change based upon user input of desired components. In addition, the communication interface would potentially allow for Web-enabled monitoring and real time updates of system components and circuitry. The user would only need to plug the above components (solar array, charge controller, battery bank and inverter) into the standardized ports located on the apparatus. The calculated fuses/breakers would be added to the apparatus by plugging in to the appropriate standardized fuse holder/breaker locations on the apparatus. The apparatus may provide a main shutoff switch to disable the apparatus.

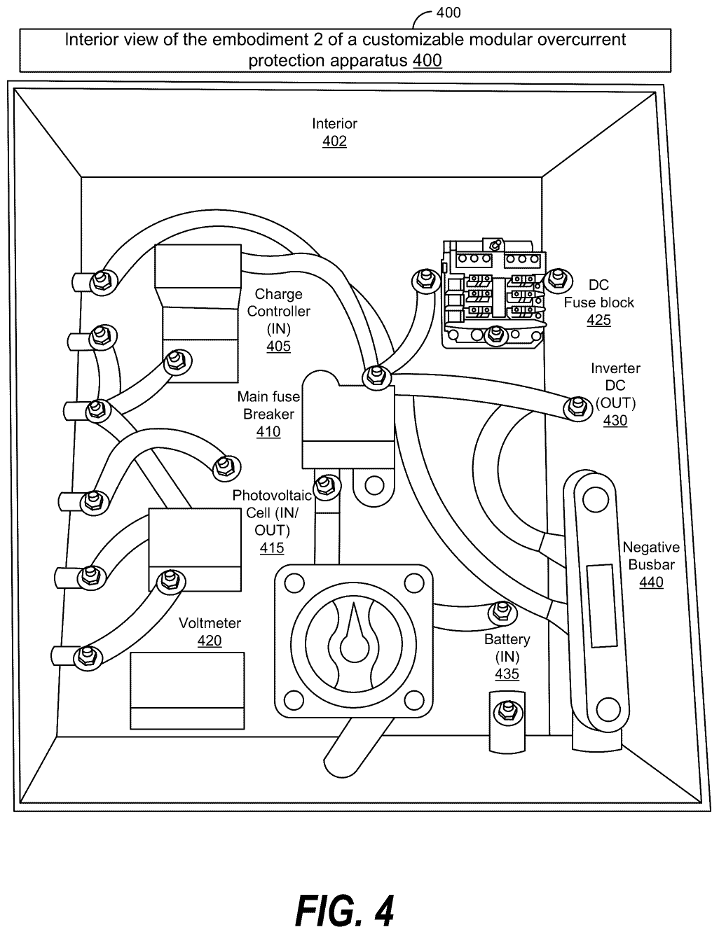

FIG. 4 depicts an interior 402 of schematic view 400 of the embodiment 2 of the customizable modular overcurrent protection apparatus 300. The charge controller (IN) 405 has both positive and negative ports. The positive port of charge controller (IN) 405 is operatively connected to the main fuse breaker 410 which connected to the DC fuse block 425 and inverter DC out 430. The negative port of the charge controller (IN) 405 is operably connected to the negative busbar 440, battery (IN) 435, photovoltaic (IN/OUT) 415, and voltmeter 420.

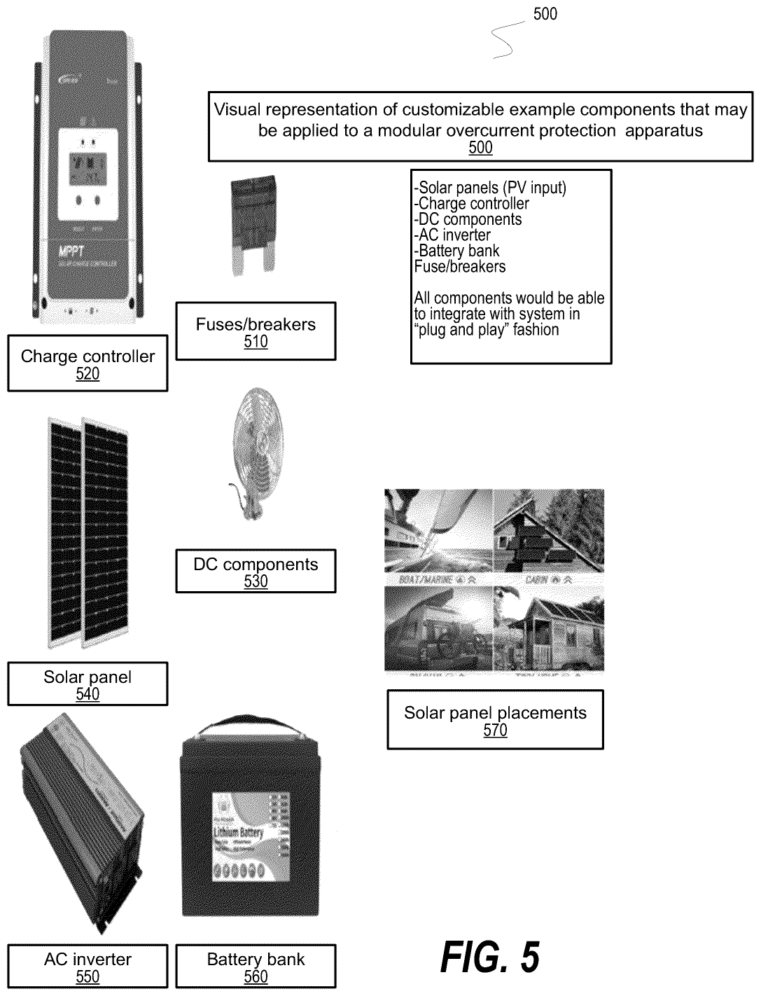

FIG. 5 depicts a visual representation of customizable components 500 that may be applied to the modular overcurrent protection apparatus. The customizable components 500 may include fuses/breakers 510, charge controller 520, DC components 530, solar panel 540, AC inverter 550, battery bank 560. Possible solar panel placements 570 are shown, for example, on roof tops. In an embodiment, components could be integrated with the apparatus in a “plug and play” fashion.

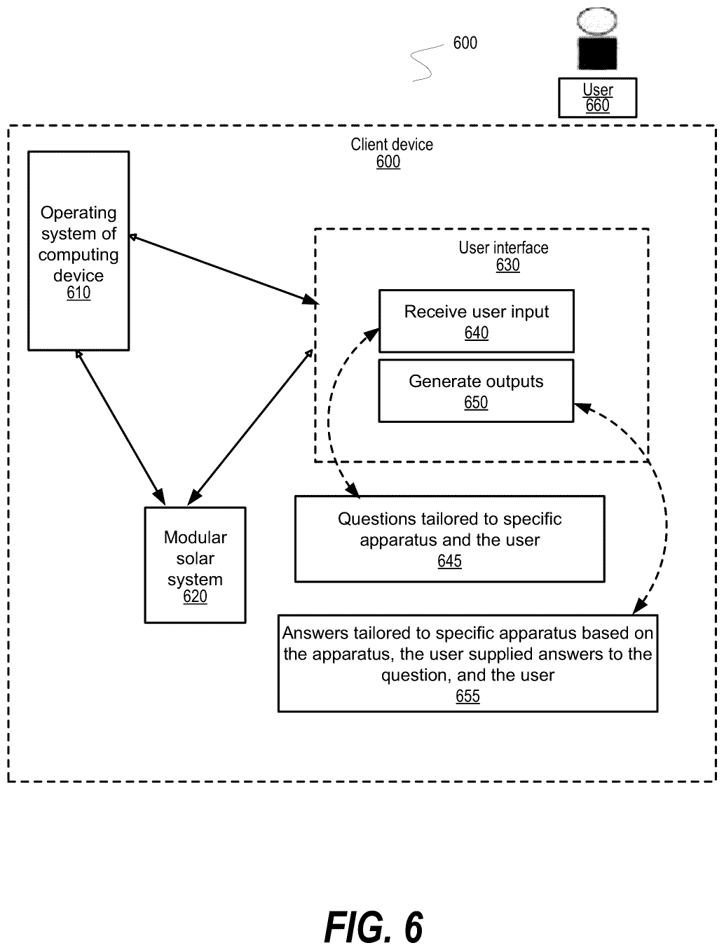

FIG. 6 depicts a client device 600 which run on an operating system of computing device 610, modular overcurrent protection system 620 supports user interface 630 which receive user input 640 from user 660, and responsive to receiving the user input 640, generates outputs 650. The questions may be tailored to the specific apparatus and user 645. The answers tailored to specific apparatus are based on the apparatus, the user supplied answers to the questions, and the user 655. The user interface 630 may be of any form. In an embodiment, the user interface may take a graphical form with menus allowing for selectable items. In a different embodiment, the user may enter values and support may be provided in a data base to look up items and offer characteristics that the user may select. The user interface 630 may also have crowd sourcing or artificial intelligence (AI) characteristics that allow for learning based on feedback from experts or multiple users. Support may include mining information about the user 645. In an embodiment, the user accesses the user interface 630 via a smart phone and retrieves information from the smart phone. The information could include social media postings, calendar, location access, weather application, and the like to derive intended usage of the apparatus. The user interface 630 may then be able to confirm intended usage of the apparatus from the user 645. The user interface 630 could be a simple command line interface using support like short message service (SMS) or even a voice response system. A user would be able to create a customized overcurrent protection generation and storage system which may be referenced herein as an apparatus. The apparatus may be an enclosure containing the required circuitry, the overcurrent protection, and a user interface to allow creation of a plug and play customizable energy generation and storage system. The integrated user interface would calculate appropriate overcurrent protection elements (or necessary solar components, in some embodiments) based upon user inputs.

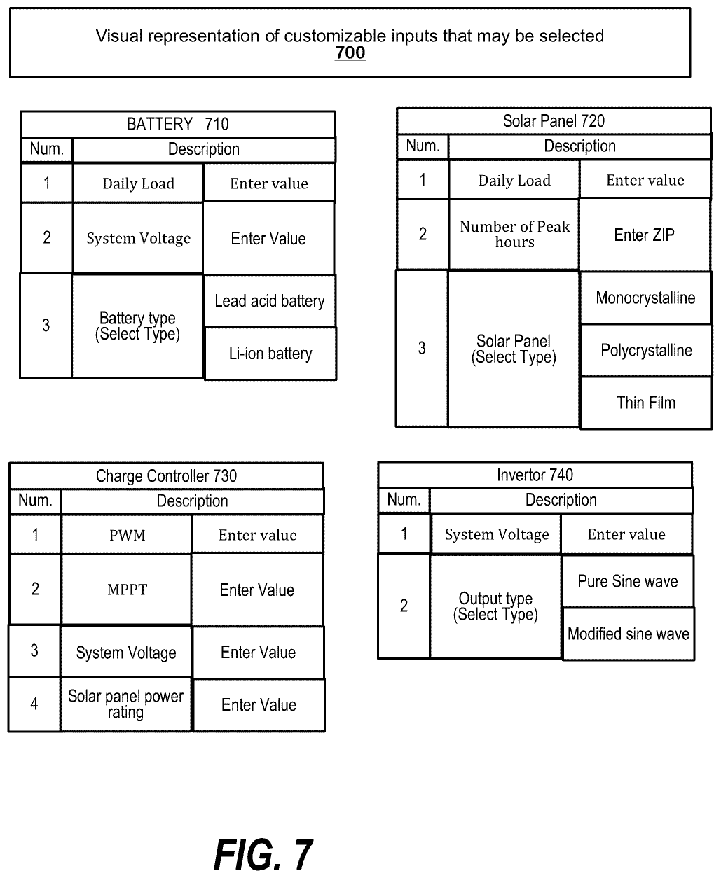

FIG. 7 depicts an input user interface (UI) 700 corresponding to user input 640 discussed in FIG. 6. The user input 640 will assist the user with determining the solar components necessary to develop a custom solar energy generation system according to their power needs. The user inputs 640 will be specific to each users desired system needs. The user need to input the details corresponding to the following components and energy requirements:—Battery 710, Solar Panel 720, Charge Controller 730, Inverter 740. The details of input for components and energy requirements may be assisted by interactions with the user may include, but are not limited to many of the following:
1) Battery (710)
   a) Daily Load—The daily load can be defined as the expected daily energy consumption or load by the user, for a desired solar energy generation system. The user would input specific power ratings and time usage for devices to be powered by the solar energy generation system. Load consumption can be defined by Load=power (watts)×time (hrs)
   b) System voltage—12 Volts/24 Volts/48 volts
   c) Type of Battery—Lead Acid battery (50% Depth of Discharge)—off the grid full-time, less maintenance
      i) Li-ion Battery (80% Depth of Discharge)—longer lifetime, higher efficiencies, and higher energy density.
2) Solar Panel (720)—Solar Panel converts the sunlight into electricity. A specific amount of sun's energy can be converted to electricity by the solar panel since they are not 100% efficient and they cannot trap the full energy of sunlight. Most of the solar panels are less than 20% efficient, which means that they can just trap about 20% of sunlight energy.
   a) Daily Load
   b) Number of peak sun hours—The number of peak sun hours can be identified using the GPS system available in the UI or by using the ZIP code of the user area.
   c) Type of Solar Panel Efficiency
      i) Monocrystalline—Monocrystalline solar cells are more efficient because they are cut from a single source of silicon. The efficiency can range from 17% to 22%.
      ii) Polycrystalline—Polycrystalline solar cells are blended from multiple silicon sources and are slightly less efficient. Efficiency ratings will typically range from 15% to 17%.
      iii) Thin Film—Thin-film solar panels are made by depositing a thin layer of a photovoltaic substance onto a solid surface, like glass. Efficiency ratings will typically range from 10% to 13%.
3) Charge Controller (730):
   a) Pulse Wave Modulation (PWM)—Its function is to pull down the voltage of the solar array to near that of the battery to ensure that the battery is properly charged.
   b) Maximum Power Point Tracking (MPPT)—MPPT charge controller extracts the maximum power from the PV module by forcing the PV module to operate at a voltage close to the Maximum Power Point (MPP).
   c) System Voltage: 12 Volt/24 Volt/48 Volt
   d) Solar Panel Power Rating (Watts)
4) Inverter (740):
   a) System Voltage (DC): 12/24/48 Volt
   b) Pure Sine Wave
   c) Modified Sine Wave

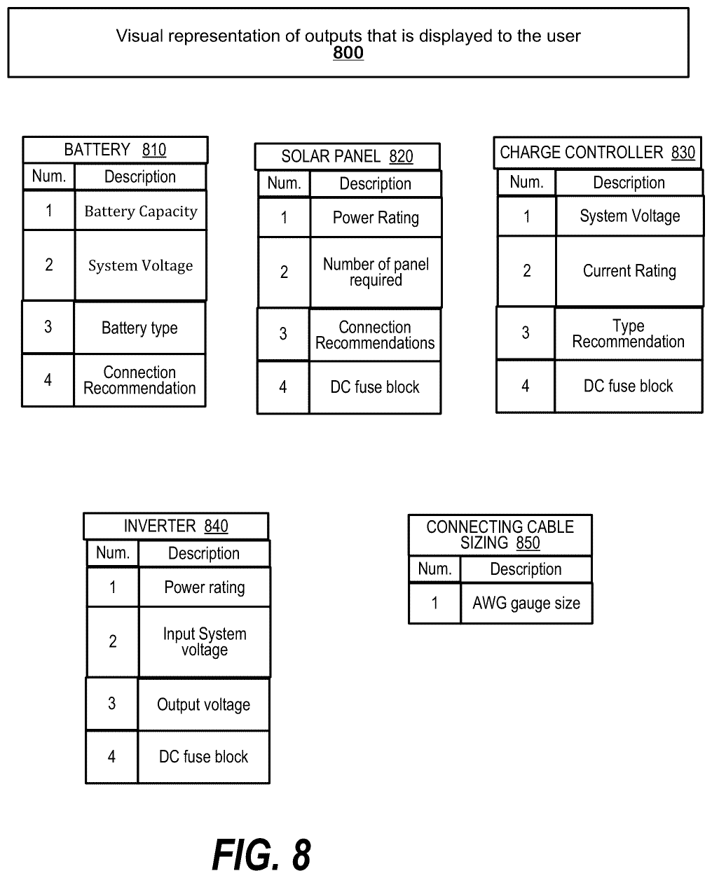

Based on the given input, as shown in FIG. 8 the software/AI calculates the FIG. 7 depicts an output UI 800 corresponding to user input 640 discussed in FIG. 6. The user input 640 will assist suggest components configurations outputs 800 based on the aforementioned load requirements calculations.
1) Battery (810):
   a. Battery Capacity (Amp Hours)
   b. System Voltage
   c. Connection Recommendations (Series or Parallel)
   d. Battery Type Recommendations (Lead Acid or Lithium Ion)
2) Solar Panel (820):
   a. Power Rating (Watts)
   b. Number of Panels Required
   c. Connection Recommendations (Series or Parallel)
   d. DC Fuse block
3) Charge Controller (830):
   a. System Voltage: 12 Volt/24 Volt/48 Volt
   b. Current Rating (Amps)
   c. Type Recommendations (PWM or MPPT)
   d. DC fuse block
4) Inverter (840):
   a. Power Rating (Continuous Watts/Surge Watts)
   b. Input System Voltage: 12/24/48 Volt
   c. Output Voltage (AC): 120 Volt/240 Volt
5) Connecting Cable Sizing (850):
   a. AWG Gauge Size

In addition, the program encompasses a comprehensive repository of information pertaining to all the options delineated within the input and output parameters. This feature is deliberately designed to ensure that individuals, including those with limited technical knowledge, can readily comprehend the nuances of the various terminologies and choices presented through the user interface. The program strives to clarify complex solar energy system-related concepts by providing clear and concise explanations rendering the decision-making process accessible and comprehensible to a broad spectrum of users.

Further, based on the suggested components configurations outputs from FIG. 8, the program is further able to provide suggestions for the customizable overcurrent protection elements. For example, based on the solar panel power ratings 810 and system voltage, the program determines the requirements for a first current overprotection element for the first location (i.e between the DC input and the charge controller) with a first current overprotection amperage rating at least 1.25 times the first solar panel amperage.

Similarly, based on the charge controller specifications output 830 the program determines the requirements for the second current overprotection element for the second location (i.e between the charge controller and the battery bank) with a second current overprotection amperage rating at least 1.25 times the amperage for the charge controller.

Further, based on the invertor specifications outputs 840 and user input voltage, the program determines current overprotection element at the third location by determining amperage as wattage divided by voltage and multiplying the amperage by at least 1.25.

For example, a user may desire a small 3600 Watt off-grid solar energy generation system based upon their anticipated load calculations. The apparatus may provide all required internal circuitry of varying current ratings in a printed circuit board (PCB) format along with over current protection elements to conjoin the solar components thus allowing for creation of the user defined system. In addition, the UI could be integrated into the apparatus (or external via software or application form) to be responsive to user input and suggest proper over current protection elements needed for desired system breakers that attach to the apparatus in a plug and play fashion to defined location on the apparatus circuit board based upon UI recommended amperage ratings. The solar components would also attach to the apparatus at defined locations with plug and play compatibility.

The UI may suggest appropriate size components: solar panel, charge controller, battery bank, inverter, etc. The fuse/breakers would be adaptable and customizable based on the current load requirements as defined by the user. The apparatus may include a communication interface suitable for Web enabled monitoring, electronic notifications of system status, and/or remote control of system functions.

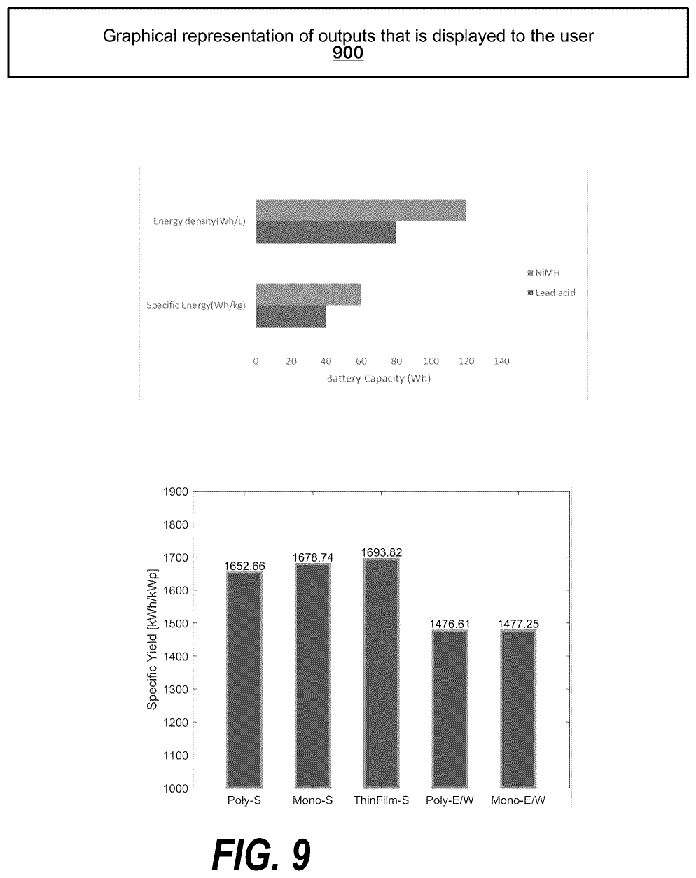

As shown in FIG. 9 the output generated by the Software/AI program is presented to the user in a graphical format via the user interface (UI). The graphical representations serve to enhance user understanding and decision-making regarding their customized solar energy generation system. Various graphical representations can be employed to convey information effectively, including but not limited to:
a) Bar Charts: Bar charts can be used to illustrate component recommendations, making it easy for users to compare different options such as battery types, solar panel efficiency, or inverter types.
b) Line Graphs: Line graphs can depict the relationship between variables, helping users visualize the impact of changing parameters, such as system voltage or daily load, on the performance of their solar system.
c) Pie Charts: Pie charts are useful for showing the distribution of energy consumption across various devices, giving users a clear breakdown of where their power is being utilized.
d) Flowcharts: Flowcharts can demonstrate the step-by-step decision-making process within the software, guiding users through the configuration of their solar system components.
e) Heat maps: Heat maps can represent geographical variations in solar energy potential, aiding users in understanding the regional impact on solar panel efficiency and power generation.
f) Icon-Based Layouts: Using icons and visual cues, the UI can provide an intuitive representation of component configurations, making it accessible to users with varying levels of technical expertise.
g) Interactive Diagrams: Interactive diagrams allow users to explore different scenarios by adjusting parameters in real-time, providing instant feedback on how changes affect the overall system design.

By employing these graphical representations, the Software/AI program simplifies complex calculations but also enhances the user's ability to make informed decisions about their solar energy generation system.

Determining appropriate overcurrent protection is a well-known engineering problem where Ohm's law applies. Ohm's law states that the current through a conductor between two points is directly proportional to the voltage across the two points. Introducing the constant of proportionality, the resistance, one arrives at the usual mathematical equation that describes this relationship: I=V/R, where I is the current in units of amperes, V is the voltage measured across the conductor in units of volts, and R is the resistance of the conductor in units of ohms.

The UI determines answers to the common engineering questions. Many will be determined by the specific embodiment of the supplied apparatus and be identified by default values. Examples of common engineering questions that may be assisted by interactions with the user may include, but are not limited to many of the following:

What is the normal operating current of the circuit?
a. In order to select the right amperage of the fuse, the full-load steady-state current of the circuit at an ambient temperature of 25Q C (68Q F) is typically used. Once the current value is determined, then a fuse rating should be selected as to be 135% of this value (taken to the next standard value).
b. For example, if the normal steady-state current is calculated to be 10 amps, then a 15 A fuse rating should be selected [10 amps×125%=12.5 amps, the next larger standard size is 15 A].
c. It is important to note that if the fuse is intended to be used in an environment with possibly very high or low ambient temperatures, then the nominal fuse current would need to be sized significantly higher or lower.

What is the operating voltage?
a. The basic rule of thumb is that the voltage rating of the fuse must always be higher than the voltage rating of the circuit that it is protecting.
b. For example, if the circuit voltage is 24 volts, then the fuse voltage rating must be higher than 24 volts (yes . . . it can be 250 V, just so long as it's higher than the circuit voltage).

What is the operating ambient temperature?
a. This may be determined by interactive questions to the user. A rule of thumb is that for every 20° C. higher or lower in temperature, the fuse should be re-rated higher or lower 10-15%.

What is the available short-circuit current?
a. This may be determined by interactive questions to the user.

What is the maximum allowable I²t?
a. All overcurrent protective devices take a certain amount of “reaction time” when they open to clear a circuit fault. During the time it takes for the fuse to open, there is energy flowing through the fuse. That energy is measured in 12t. There two parts to the fuse's “reaction time”.
   i. The time it takes to melt the fuse element (also known as the melting time, Tm).
   ii. The time it takes to quench the electrical arc (also known as the arcing time, Ta). The total time open the fault is known as the total clearing time. Tc+Tm+Ta

Many other common engineering questions may be determined by the apparatus being offered. For example, the apparatus may be a DC circuit and may be designed to handle one or more of the following rush currents, short-circuit protection, over-load protection with known physical size limitations.

The following are options regarding the mounting of the fuse in the circuit:
1) Fuse Clips—Fuse clips are relatively inexpensive and allow for field replaceability. Fuse clips are typically mounted on a PCB so any attempt at replacing the fuse will require opening of the piece of equipment by the user 655. Additionally, removing a fuse from a PCB without disconnecting the power source could lead to an electrical shock when touching the fuse. Fuse clips are available for all “tube” fuses as well as micro fuses. Typically, fuse clips are limited to 15 A of normal current. Fuse clips are generally not listed or recognized by any safety agencies.
2) Panel Mounted Fuse holders—Panel mounted fuse holders allow for easy access for the user 655 to replace the fuse in the field. The panel mount fuse holder is shock-safe meaning that the fuse is removed safely when the cap of the fuse holder is removed preventing the possibility of electrical shocks. Fuse holders are typically tested and approved by safety agencies such as UL and CSA. Fuse holders are mounted in fuse blocks are typically only accessible by opening the piece of equipment which could lead to electrical shocks if the equipment is not disconnected from the power source. Fuse blocks are one of the few methods to mount fuses of large amperage.
3) Inline Fuse Holders—In line fuse holders are typically used as a part of a wire harness assembly or where no surface is available to secure another type of fuse mount. Ln line fuse holders are generally available up to 100 A in lower voltage applications and up to 30 A in higher voltage applications.

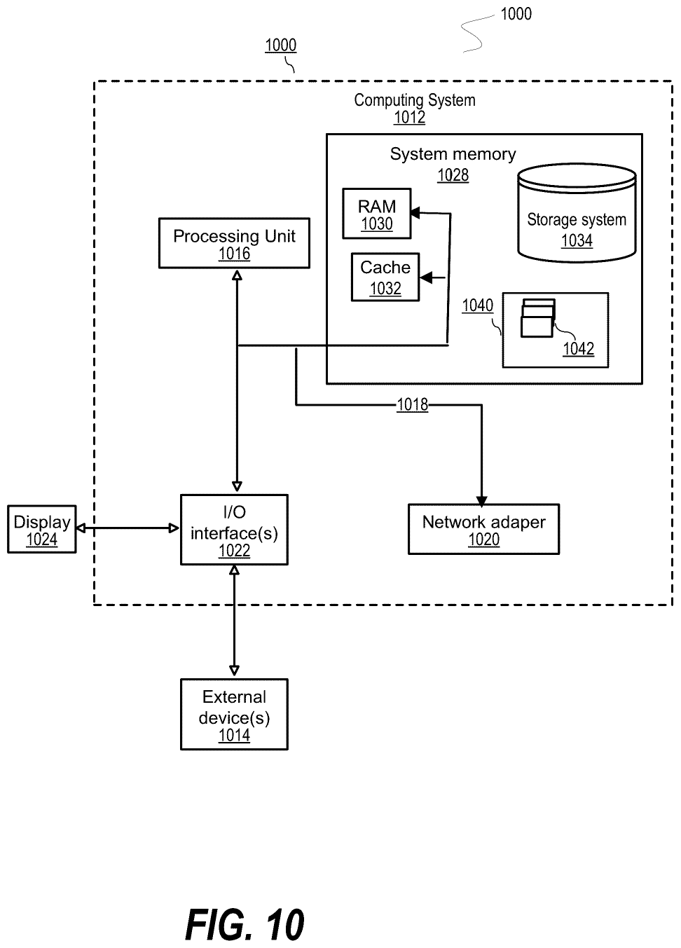

Referring to FIG. 10, a schematic of a processing system 1000 is shown wherein the methods of this invention may be implemented. The processing system 1000 is only one example of a suitable system and is not intended to suggest any limitation as to the scope of use or functionality of embodiments of the invention described herein. Regardless, the system 1000 can implement and/or performing any of the functionality set forth herein. In the system 1000 there is a computer system 1012, which is operational with numerous other general purpose or special purpose computing system environments or configurations. Examples of well-known computing systems, environments, and/or configurations that may be suitable for use with the computer system 1012 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 1012 may be described in the general context of computer system-executable instructions, such as program modules, being executed by a computer system. Generally, program modules may include routines, programs, objects, components, logic, data structures, and so on that perform tasks or implement abstract data types. The computer system 1012 may be practiced in distributed cloud computing environments where tasks are performed by remote processing devices that are linked through a communications network. In a distributed cloud computing environment, program modules may be in both local and remote computer system storage media including memory storage devices.

As shown in FIG. 10, the computer system 1012 in the system environment 1000 is shown in the form of a general-purpose computing device. The components of the computer system 1012 may include, but are not limited to, a set of one or more processors or processing units 1016, a system memory 1028, and a bus 1018 that couples various system components including the system memory 1028 to the processor 1016.

The bus 1018 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnects (PCI) bus.

The computer system 1012 typically includes a variety of computer system readable media. Such media may be any available media that is accessible by the computer system 1012, and it includes both volatile and non-volatile media, removable and non-removable media.

The system memory 1028 can include computer system readable media in the form of volatile memory, such as random-access memory (RAM) 1030 and/or a cache memory 1032. The computer system 1012 may further include other removable/non-removable, volatile/non-volatile computer system storage media. By way of example only, a storage system 1034 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1018 by one or more data media interfaces. As will be further depicted and described below, the system memory 1028 may include at least one program product having a set (e.g., at least one) of program modules 1042 that are configured to carry out the functions of embodiments of the invention.

A program/utility 1040, having the set (at least one) of program modules 1042, may be stored in the system memory 1028 by way of example, and not limitation, as well as an operating system, one or more application programs, other program modules, and program data. Each of the operating systems may have one or more application programs, other program modules, and program data or some combination thereof, and may include an implementation of a networking environment. The program modules 1042 generally carry out the functions and/or methodologies of embodiments of the invention as described herein.

The computer system 1012 may also communicate with a set of one or more external devices 1014 such as a keyboard, a pointing device, a display 1024, a tablet, a digital pen, etc. wherein these one or more devices enable a user to interact with the computer system 1012; and/or any devices (e.g., network card, modem, etc.) that enable the computer system 1012 to communicate with one or more other computing devices. Such communication can occur via Input/Output (I/O) interfaces 1022. These include wireless devices and other devices that may be connected to the computer system 1012, such as, a USB port, which may be used by a tablet device (not shown). Still yet, the computer system 1012 can communicate with one or more networks such as a local area network (LAN), a general wide area network (WAN), and/or a public network (e.g., the Internet) via a network adapter 1020. As depicted, a network adapter 1020 communicates with the other components of the computer system 1012 via the bus 1018. It should be understood that although not shown, other hardware and/or software components could be used in conjunction with the computer system 1012. Examples include, but are not limited to microcode, device drivers, redundant processing units, external disk drive arrays, RAID systems, tape drives, and data archival storage systems, etc.

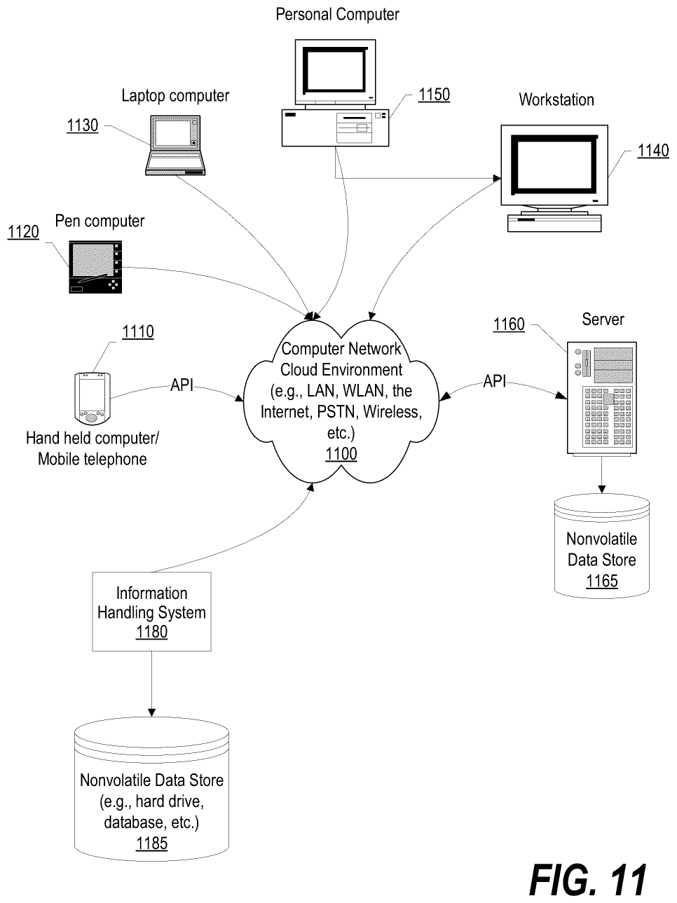

FIG. 11 depicts that the system is adaptable for implementation across a diverse range of computing platforms and devices, making it highly versatile and accessible to users. Said system can be efficiently deployed on mobile phones 1110, pen computers 1120, laptop computers 1130, personal computers 1140, workstations 1150, and servers 1150, among other computing environments. This adaptability enables users, irrespective of their chosen computing device or platform, to access system user-friendly interface and integrated software/AI, facilitating the generation of personalized solar system recommendations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention.

Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

We claim:

1. A method for assisting a user with configuring an integrated circuit with a plurality of customizable modules configured to integrate a customizable solar energy generation system comprising:
providing a user interface (UI) allowing a user to specify inputs to the customizable modules;
responsive to the user utilizing the UI and providing load inputs related to the customizable modules, generating outputs tailored to the load inputs; and
installing at least one customizable module into the integrated circuit.

2. The method of claim 1, wherein the customizable modules are selected from a group consisting of battery, solar panel, charge controller and inverter.

3. The method of claim 2, wherein the generated outputs for a battery customizable module further comprises:
recommending battery capacity, system voltage, battery type and connection recommendations for series and parallel.

4. The method of claim 2, wherein the generated outputs for a solar panel customizable module further comprises:
recommending power rating, number of panels required, connection recommendations for series and parallel circuits, and at least one current overprotection element.

5. The method of claim 2, wherein the generated outputs for a charge controller customizable module further comprises:
recommending power rating, number of panels required, connection recommendations, system voltage, current rating, type of charge controllers, and at least one current overprotection element.

6. The method of claim 2, wherein the generated outputs for an inverter customizable module further comprises:
recommending power rating, input system voltage, output voltage, type of charge controllers, and at least one current overprotection element.

7. The method of claim 1, wherein the generated output related to the customizable modules is displayed graphically to user.

8. The method of claim 2, wherein the specified inputs for the battery are daily load, system voltage and battery type.

9. The method of claim 2, wherein the specified inputs for the solar panels are daily load, number of peak hours and solar panel type.

10. The method of claim 1, wherein the specified inputs for the charge controller are pulse-width modulation (PWM), Maximum power point tracking (MPPT), system voltage and solar panel power rating.

11. The method of claim 1, wherein the specified inputs for the inverter are system voltage and output power type.

12. The method of claim 11, wherein the output recommendations for the inverter are power rating, input system voltage, output voltage, type of charge controllers, and at least one current overprotection element.

13. An information handling system for assisting a user with configuring an integrated circuit with a plurality of customizable modules for construction of a customizable solar energy generation system comprising:
one or more processor,
a memory coupled to atleast one of the processors
a network interface that connects a local device to another device, and a set of computer program instructions stored in the memory and
executed by atleast one of the processors in order to perform actions comprising:
providing a user interface (UI) allowing a user to specify inputs to the customizable modules;
responsive to the user utilizing the UI and providing load inputs related to the customizable modules, generating outputs tailored to the load inputs; and
installing at least one customizable module into the integrated circuit.

14. The information handling system of claim 13,
wherein the customizable modules are selected from a group consisting of battery, solar panel, charge controller and inverter.
